(19) United States
(12) Patent Application Publication
(10) Pub. No.: US 2025/0358891 A1
(43) Pub. Date: Nov. 20, 2025

(54) COMMUNICATION METHOD, REPEATER NODE, NON-TRANSITORY COMPUTER-READABLE MEDIUM, CHIPSET AND SYSTEM

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/286,804

(22) Filed: Jul. 31, 2025

Related U.S. Application Data
(63) Continuation of application No. PCT/JP2024/002220, filed on Jan. 25, 2024.

(30) Foreign Application Priority Data
Feb. 2, 2023 (JP) 2023-014895

(51) Int. Cl. H04W 76/27; H04W 84/04

(52) U.S. Cl. CPC H04W 76/27; H04W 84/047

(57) ABSTRACT

A communication method using a relay apparatus including a relay device configured to perform a relay operation of relaying a radio signal transmitted between a network and a user equipment, and a control terminal configured to receive a control signal used for control of the relay device from the network, the communication method including: transitioning, by the control terminal, to a radio resource control (RRC) idle state; and determining, by the relay apparatus, that the control from the network is not present, in response to the transitioning to the RRC idle state.

### RELATED APPLICATIONS

The present application is a continuation based on PCT Application No. PCT/JP2024/002220, filed on Jan. 25, 2024, which claims the benefit of Japanese Patent Application No. 2023-014895 filed on Feb. 2, 2023. The content of which is incorporated by reference herein in their entirety.

### TECHNICAL FIELD

The present disclosure relates to a communication method used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and user equipment and can be controlled from a network is attracting attention (see, for example, Non-Patent Document 1). Such a repeater apparatus can extend the coverage of the base station while suppressing occurrence of interference by, for example, amplifying a radio signal received from the base station and transmitting the radio signal through directional transmission. Note that such a repeater apparatus is referred to as a network-controlled repeater (NCR).

### CITATION LIST

### Non-Patent Literature

Non-Patent Document 1: 3GPP Contribution: RP-213700, “New SI: Study on NR Network-controlled Repeaters”

### SUMMARY

A communication method according to a first aspect is a communication method using a relay apparatus including a relay device configured to perform a relay operation of relaying a radio signal transmitted between a network and a user equipment, and a control terminal configured to receive a control signal used for control of the relay device from the network, the communication method including the steps of: transitioning, by the control terminal, to a radio resource control (RRC) idle state; and determining, by the relay apparatus, that the control from the network is not present, in response to the transitioning to the RRC idle state.

A communication method according to a second aspect is a communication method using a relay apparatus including a relay device configured to perform a relay operation of relaying a radio signal transmitted between a network and a user equipment, and a control terminal configured to receive a control signal used for control of the relay device from the network, the communication method including the steps of: receiving, by the control terminal, in a radio resource control (RRC) connected state, configuration information used to configure the relay operation from the network; transitioning, by the control terminal, to an RRC idle state or an RRC inactive state; and performing, by the relay apparatus, in the RRC idle state or the RRC inactive state, an operation in accordance with the configuration information only during a period until a certain amount of time elapses after the transitioning.

A communication method according to a third aspect is a communication method using a relay apparatus including a relay device configured to perform a relay operation of relaying a radio signal transmitted between a network and a user equipment, and a control terminal configured to receive a control signal used for control of the relay device from the network, the communication method including the steps of: causing, by a network node included in the network, the control terminal to transition from a radio resource control (RRC) connected state to an RRC idle state; and transmitting, by the network node, a paging request to a core network apparatus included in the network, the paging request requesting paging from the core network apparatus to the relay apparatus.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario for an NCR apparatus (relay apparatus) according to the embodiment.

FIG. 5 is a diagram illustrating an example of the application scenario for the NCR apparatus according to the embodiment.

FIG. 6 is a diagram illustrating an example of a control method for the NCR apparatus according to the embodiment.

FIG. 7 is a diagram illustrating a configuration example of a protocol stack in the mobile communication system including the NCR apparatus according to the embodiment.

FIG. 8 is a diagram illustrating a concrete configuration example of a mobile communication system 1 including the NCR apparatus according to the embodiment.

FIG. 9 is a diagram illustrating a configuration example of the NCR apparatus according to the embodiment.

FIG. 10 is a diagram illustrating a configuration of a user equipment (UE) according to the embodiment.

FIG. 11 is a diagram illustrating a configuration example of a gNB (base station) according to the embodiment.

FIG. 12 is a diagram for explaining an operation according to a first embodiment.

FIG. 13 is a flowchart illustrating an operation example of an NCR apparatus according to the first embodiment.

FIG. 14 is a flowchart illustrating an operation example of an NCR apparatus according to a variation of the first embodiment.

FIG. 15 is a flowchart illustrating an operation example of an NCR apparatus according to a second embodiment.

FIG. 16 is a diagram illustrating an operation example of a mobile communication system according to a third embodiment.

FIG. 17 is a diagram for explaining a relay apparatus according to a fourth embodiment.

FIG. 18 is a diagram for explaining the relay apparatus according to the fourth embodiment.

### DESCRIPTION OF EMBODIMENTS

A mobile communication system according to an embodiment is described with reference to the drawings. In the description of the drawings, the same or similar parts are denoted by the same or similar reference signs.

### (1) First Embodiment

A first embodiment will be described first. A relay apparatus according to the embodiment is a repeater apparatus (i.e., NCR apparatus) that can be controlled from a network.

### (1.1) Overview of Mobile Communication System

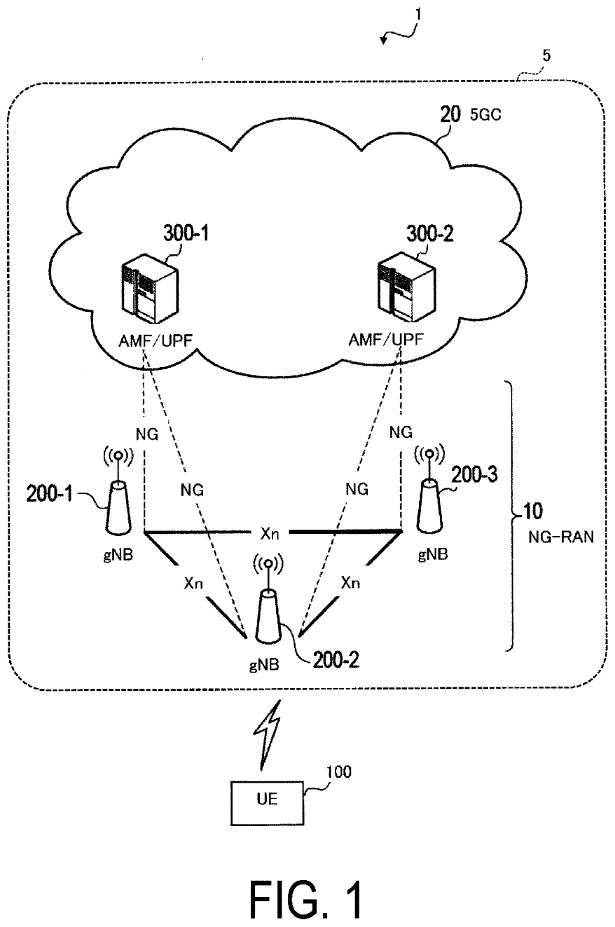

FIG. 1 is a diagram illustrating a configuration of a mobile communication system according to an embodiment.

A mobile communication system 1 complies with the 5th Generation System (5GS) of the 3rd Generation Partnership Project (3GPP; registered trademark, the same applies below) standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to an adjacent base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

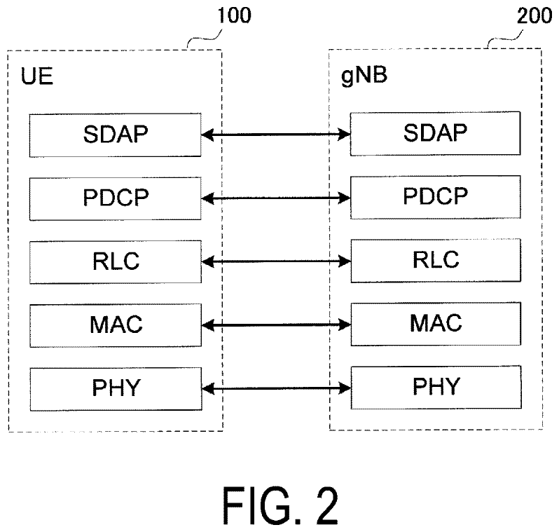

FIG. 2 is a diagram illustrating a configuration of a protocol stack of a wireless interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. A Cyclic Redundancy Code (CRC) bit scrambled by the RNTI is added to the DCI transmitted from the gNB 200.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20RB.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

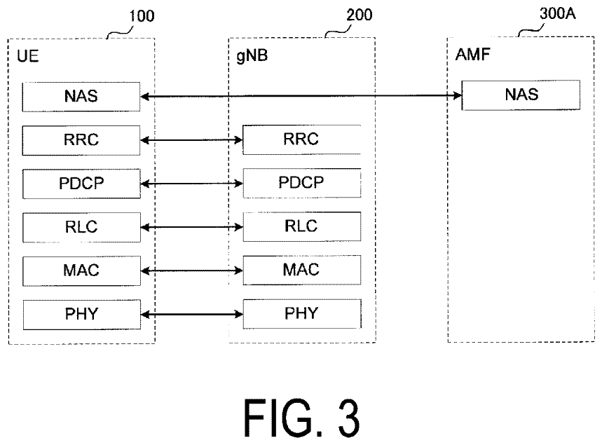

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (1.2) Application Scenario Example for Relay Apparatus

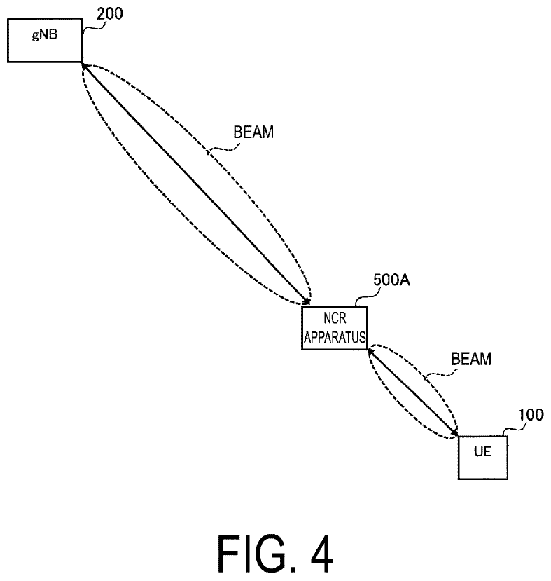

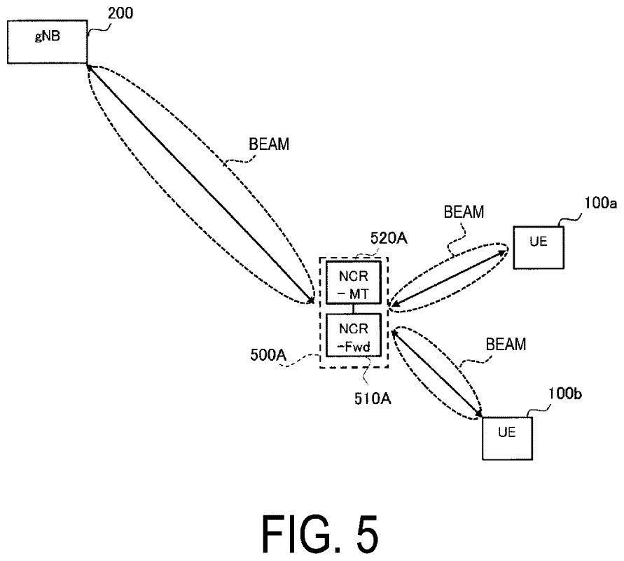

FIGS. 4 and 5 are diagrams illustrating an example of an application scenario of the NCR apparatus according to the embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, a repeater apparatus (500A) that is a type of a relay apparatus relaying radio signals between the gNB 200 and the UE 100, and can be controlled from the network is introduced into the mobile communication system 1. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

As illustrated in FIG. 5, a new UE (hereinafter referred to as an “NCR-MT (Mobile termination)”) 100B that is a type of the control terminal for controlling the NCR apparatus 500A is introduced. That is, the NCR apparatus 500A includes an NCR-Fwd (Forward) 510A, which is a type of a relay device that relays a radio signal transmitted between the gNB 200 and the UE 100, concretely, changes a propagation state of the radio signal without demodulating or modulating the radio signal, and an NCR-MT 520A that performs wireless communication with the gNB 200 to control the NCR-Fwd 510A. Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. Note that the NCR-MT 520A also has a function similar to and/or the same as the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. The NCR-MT 520A may be configured to be integrated with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed in, for example, a vehicle and be movable. One NCR-MT 520A may control a plurality of NCR-Fwds 510A.

Note that the invention is not limited to a configuration in which the NCR-MT 520A directly controls one or more NCR-Fwds 510A, but may have a configuration in which the NCR-MT 520A indirectly controls one or more NCR-Fwds 510A. For example, the NCR-MT 520A may control one or more NCR-Fwds 510A via an upper layer (for example, application layer).

In the example illustrated in FIG. 5, the NCR apparatus 500A (NCR-Fwd 510A) dynamically or semi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beam forming, the NCR-Fwd 510A may perform null forming (so-called null steering) toward the UE 100 which is not a communication partner (not illustrated) and/or a neighboring gNB 200 (not illustrated) to curb interference.

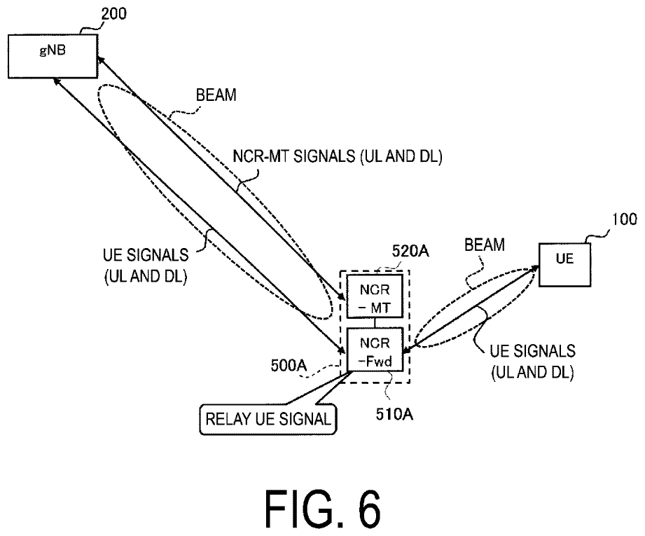

FIG. 6 is a diagram illustrating an example of a control method for the NCR apparatus 500A according to the embodiment. As illustrated in FIG. 6, the NCR-Fwd 510A relays a radio signal (referred to as a “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (referred to herein as a “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling (for example, NCR control signal) for controlling the NCR apparatus 500A. The radio link between the NCR-MT 520A and the gNB 200 is also referred to as a “control link”.

The gNB 200 directs a beam to the NCR-MT 520A, based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

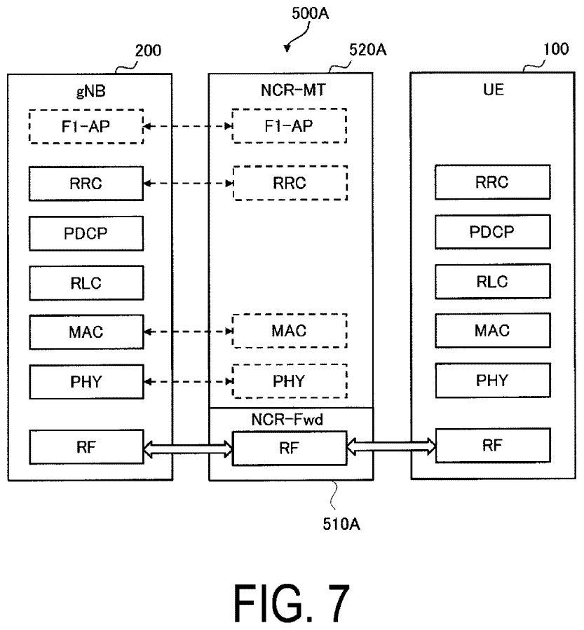

FIG. 7 is a diagram illustrating a configuration example of a protocol stack in the mobile communication system 1 including the NCR apparatus 500A according to the present embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) selected from the group consisting of PHY, MAC, RRC, and F1-Application Protocol (AP). The F1-AP is a type of a fronthaul interface. The NCR-MT 520A communicates signaling with the gNB 200 through at least one selected from the group consisting of the PHY, the MAC, the RRC, and the F1-AP.

When the NCR-MT 520A is a type or a part of the base station, the NCR-MT 520A may communicate with the gNB 200 through an AP of Xn (Xn-AP) which is an inter-base station interface. The NCR-MT 520A may also include a NAS layer (entity). The NCR-MT 520A communicates signaling with the AMF 300A through the NAS layer. The NAS layer may configure an upper layer for the NCR-MT 520A.

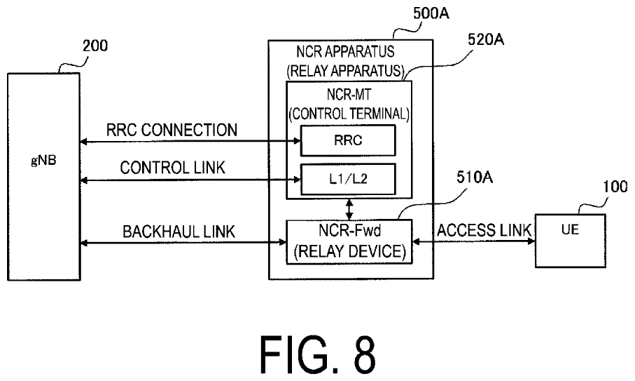

FIG. 8 is a diagram illustrating a concrete configuration example of the mobile communication system 1 including the NCR apparatus 500A according to the embodiment.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 through the backhaul link and the access link. The NCR-Fwd 510A changes a propagation state of the radio signal without demodulating or modulating the radio signal.

A control link is established between the gNB 200 and a layer-1 and/or a layer-2 (L1/L2) of the NCR-MT 520A. The L1/L2 of the NCR-MT 520A transmits and receives L1/L2 signaling to and from the gNB 200 via the control link. An RRC connection is established between the gNB 200 and the RRC of the NCR-MT 520A. The RRC of the NCR-MT 520A transmits and receives an RRC message to and from the gNB 200 via the RRC connection. The NCR-MT 520A receives downlink signaling (also referred to as “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message that is a control signal of the RRC layer (i.e., layer-3). The NCR control signal may be a MAC Control Element (CE) that is a control signal of the MAC layer (i.e., layer-2). The NCR control signal may be downlink control information (DCI) that is a control signal of the PHY layer (i.e., layer-1). The NCR control signal may be UE-specific signaling. The NCR control signal may be broadcast signaling. The NCR control signal may be a fronthaul message (for example, F1-AP message). When the NCR-MT 520A is a type or a part of the base station, the NCR-MT 520A may communicate with the gNB 200 through an AP of Xn (Xn-AP) which is an inter-base station interface. Hereinafter, the NCR control signal transmitted in the RRC message (and/or MAC CE) and used for static or semi-static control of the NCR-Fwd 510A is also referred to as “NCR configuration information” or simply “configuration information”. Here, the RRC message may be an RRC reconfiguration message. The NCR configuration information includes, for example, information for configuring ON/OFF of the NCR-Fwd 510A. The NCR configuration information may include, for example, information for a semi-static beam configuration of the NCR-Fwd 510A.

On the other hand, the NCR control signal transmitted in the DCI (and/or MAC CE) and used for dynamic control of the NCR-Fwd 510A is also referred to as “NCR control information” or simply “control information”. The NCR control information may be referred to as side control information (SCI). The CRC bits of the PDCCH carrying the NCR control information are scrambled by a newly introduced dedicated RNTI. The dedicated RNTI is also referred to as an “NCR-RNTI”. The NCR control information may include, for example, information for dynamic beam control of the NCR-Fwd 510A. The NCR configuration information may include information indicating dynamic ON/OFF of the NCR-Fwd 510A.

For example, when the NCR-MT 520A is in the RRC connected state, the NCR apparatus 500A can turn on or off the NCR-Fwd 510A in accordance with the NCR control information (SCI) received from the gNB 200. On the other hand, after the NCR-MT 520A transitions to the RRC inactive state, the NCR apparatus 500A can turn on or off the NCR-Fwd 510A in accordance with the latest (last) configuration information received from the gNB 200.

When a radio link failure (RLF) with respect to the gNB 200 is detected by the NCR-MT 520A, the NCR-MT 520A performs cell selection and triggers RRC connection reestablishment (also referred to as “RRC reestablishment”). Here, when the NCR-MT 520A enters the RRC idle state because no suitable cell is found in the cell selection, the NCR apparatus 500A turns off the NCR-Fwd 510A. Note that NCR-Fwd 510A is off during the RRC re-establishment procedure.

The NCR control signal may include frequency control information for designating a center frequency of a radio signal (for example, a component carrier) to be relayed by the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information for designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs non-directional transmission and/or reception is a mode in which the NCR-Fwd 510A performs relay in all directions and may be referred to as an omnidirectional mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (configured) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (configured) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing single-user (SU) spatial multiplexing. The mode may be a mode for performing Multi-User (MU) spatial multiplexing. The mode may be a mode for performing transmission diversity. Any of these modes may be designated (configured) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (configured) from the gNB 200 to the NCR-MT 520A in the NCR control signal.

The NCR control signal may include beam control information for designating a transmission direction, a transmission weight, or a beam pattern for the NCR-Fwd 510A to perform directional transmission. The beam control information may be associated with the frequency control information (center frequency). The beam control information may include a precoding matrix indicator (PMI). The beam control information may include beam forming angle information. When the NCR control signal received from the gNB 200 includes the beam control information, the NCR-MT 520A (controller 523) controls the NCR-Fwd 510A such that the NCR-Fwd 510A forms a transmission directivity (beam) indicated by the beam control information. Since the NCR control signal includes the beam control information, the gNB 200 can control the transmission directivity of the NCR apparatus 500A via the NCR-MT 520A.

The NCR control signal may include output control information for designating a degree at which the NCR-Fwd 510A amplifies a radio signal (amplification gain), or transmission power. The output control information may be information indicating a difference value (that is, a relative value) between a current amplification gain or transmission power and a target amplification gain or transmission power. When the NCR control signal received from the gNB 200 includes the output control information, NCR-MT 520A (controller 523) controls the NCR-Fwd 510A such that the amplification gain or transmission power is changed to an amplification gain or transmission power indicated by the output control information. The output control information may be associated with the frequency control information (center frequency). The output control information may be information for designating any one of an amplification gain, a beamforming gain, and an antenna gain of the NCR-Fwd 510A. The output control information may be information for designating transmission power of the NCR-Fwd 510A.

When one NCR-MT 520A controls a plurality of NCR-Fwds 510A, the gNB 200 (transmitter 210) may transmit the NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Configuration Example of Each Apparatus

In the embodiment, a configuration example of each apparatus in the mobile communication system 1 is described.

### (1.3.1) Configuration Example of Relay Apparatus

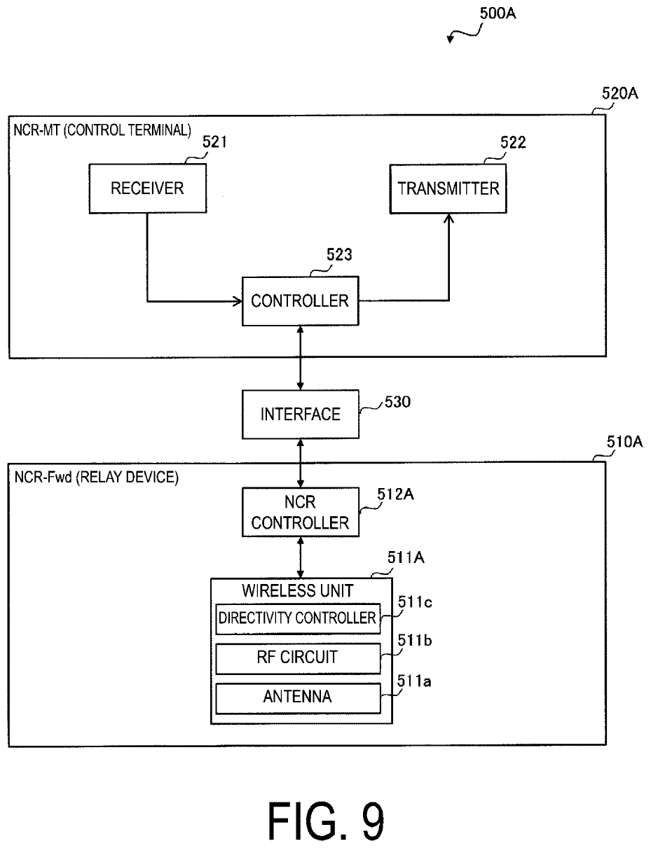

FIG. 9 is a diagram illustrating a configuration example of the NCR apparatus 500A (relay apparatus) according to the embodiment. The NCR apparatus 500A includes an NCR-Fwd 510A, an NCR-MT 520A, and an interface 530.

The NCR-Fwd 510A includes the wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operations of the NCR-MT 520A (and NCR apparatus 500A) described above and below may be also performed under the control of the controller 523. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of layer of at least one selected from the group consisting of the PHY, the MAC, the RRC, and the F1-AP.

The interface 530 electrically or logically connects the NCR-Fwd 510A to the NCR-MT 520A. The controller 523 of the NCR-MT 520A controls the NCR-Fwd 510A via the interface 530. The interface 530 may be a logical entity of an upper layer (for example, application layer).

In the embodiment, the receiver 521 of the NCR-MT 520A receives signaling (NCR control signal) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Configuration Example of User Equipment

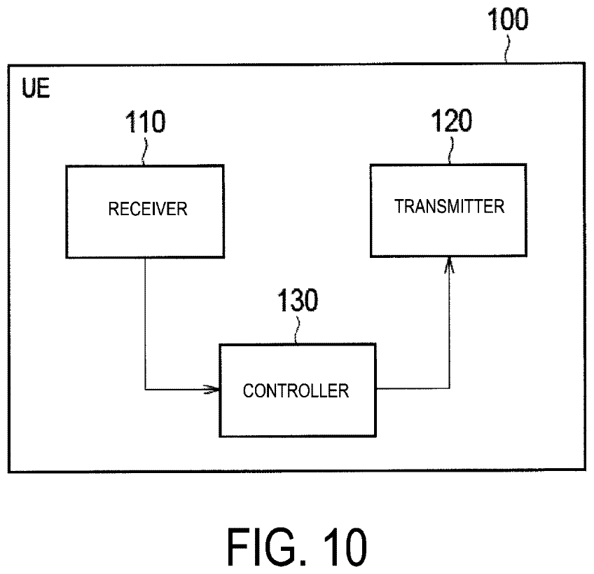

FIG. 10 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may also be performed under the control of the controller 130. The controller 130 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Configuration Example of Base Station

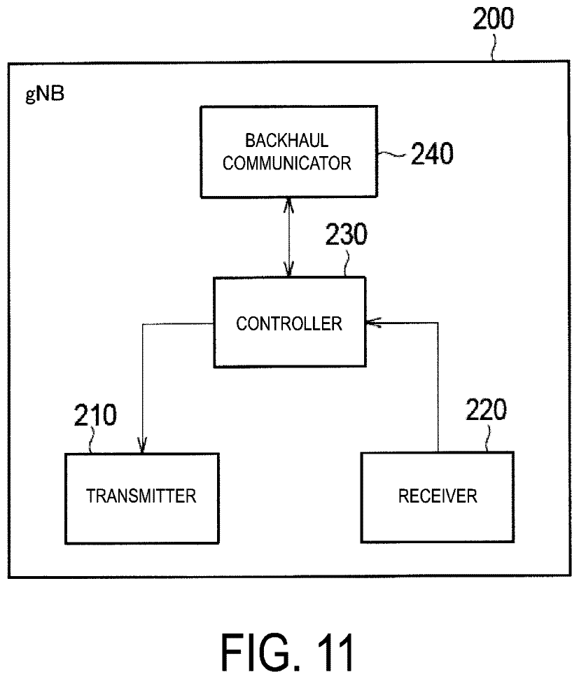

FIG. 11 is a diagram illustrating a configuration example of the gNB 200 (base station) according to the embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operations of the gNB 200 described above and below may be also performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the embodiment, the transmitter 210 of the gNB 200 transmits signaling (NCR control signal) used to control the NCR-Fwd 510A to the NCR-MT 520A through wireless communication. This enables the gNB 200 to control the NCR apparatus 500A via the NCR-MT 520A.

### (1.4) Operation According to First Embodiment

In the first embodiment, mainly assume a case where the gNB 200 causes the NCR-MT 520A to transition to the RRC idle state (that is, releases the RRC connection).

Here, it may be assumed that the NCR-MT 520A is basically in the RRC connected state (Assumption 1). In this assumption, the gNB 200 does not release the RRC connection of the NCR-MT 520A because the NCR apparatus 500A can be always controlled by the network 5. Therefore, the NCR-MT 520A may possibly enter the RRC idle state only upon an initial access (for example, upon power-on) or an RLF (precisely upon a failure of RRC re-establishment). An initial state of the NCR-Fwd 510A upon the initial access is clear (i.e., off). The NCR-Fwd 510A when transitioning to the RRC idle state due to the RLF is also off.

On the other hand, it may be also assumed that the RRC connection of the NCR-MT 520A may be possibly released by the gNB 200 (Assumption 2). In this assumption, the gNB 200 can release the RRC connection of the NCR-MT 520A in order to save power of the NCR apparatus 500A and/or reduce signaling overhead, etc. Therefore, the NCR-MT 520A may enter the RRC idle state due to all conventional conditions such as the initial access, the RLF, and the RRC release. After the NCR-MT 520A transitions to the RRC idle state, the NCR-Fwd 510A may possibly fall back to the conventional RF repeater.

The NCR apparatus 500A is network-controlled through the NCR control signal (for example side control information and RRC signaling). Assumption 1 is very simple because there is no reason for the gNB 200 to release the RRC connection of the NCR-MT 520A in the normal state. However, as in Assumption 2, there may be a case where the gNB 200 releases the RRC connection of the NCR-MT 520A under specific conditions. Since various gNB 200 implementations need to be allowed, the operation of the NCR apparatus 500A in the RRC idle state due to the RRC release needs to be clarified.

On the other hand, regarding the operation of the NCR apparatus 500A in the RRC inactive state, after the NCR-MT 520A transitions to the RRC inactive state, the NCR apparatus 500A turns on or off the NCR-Fwd 510A in accordance with the latest configuration information received from the gNB 200. Here, the NCR-MT 520A in the RRC inactive state may continue to be controlled by the gNB 200. That is, the gNB 200 can always page the NCR-MT 520A by RAN paging (i.e., a paging message transmitted according to determination of the gNB 200).

In contrast, the NCR-MT 520A in the RRC idle state cannot be controlled by the gNB 200. This is because CN paging (i.e., a paging message transmitted according to determination of the AMF 300A) is required to establish an RRC connection of the NCR-MT 520A for transmitting the side control information and the configuration information. Therefore, the operation of the NCR apparatus 500A in the RRC idle state is desired to be considered separately from that in the RRC inactive state. The operation of the NCR-Fwd 510A in the RRC inactive state may follow that in the RRC connected state and be conceivably different from that in the RRC idle state.

Furthermore, as described in Assumption 2 above, the NCR apparatus 500A may possibly fall back to the conventional RF repeater when the NCR apparatus 500A is not controlled by the gNB 200. On the other hand, the NCR apparatus 500A in the RRC inactive state may not conceivably fall back to the conventional RF repeater because the NCR apparatus 500A in the RRC inactive state turns on or off the NCR-Fwd 510A in accordance with the latest configuration received from the gNB 200. Thus, the possibility of falling back to the conventional RF repeater may only be available when the NCR-MT 520A is in the RRC idle state.

The conventional RF repeaters are of an implementation technology from a network control perspective. Thus, the NCR apparatus 500A, when falling back to the conventional RF repeater, is no longer the network-controlled repeater. In other words, when the NCR apparatus 500A is no longer network-controlled (for example when the NCR-MT 520A transitions to the RRC idle state), the operation of the NCR apparatus 500A may be implementation-dependent. In this way, when the NCR apparatus 500A is not controlled by the gNB 200 (for example, when the NCR-MT 520A transitions to the RRC idle state), the NCR apparatus 500A may not be considered as the NCR apparatus 500A from the network control perspective.

As described above, the operation of the NCR apparatus 500A in the RRC idle state due to the RRC release needs to be clarified and needs to be different from the operation in the RRC inactive state in order to permit various gNB 200 implementations. When the NCR-MT 520A enters the RRC idle state because no suitable cell is found at the time of occurrence of the RLF, the NCR-Fwd 510A is turned off. However, there may be no important reason for distinguishing the transition to the RRC idle state due to the RRC release from the transition to the RRC idle state due to the RLF. Thus, regardless of the cause of the transition to the RRC idle state, the NCR-Fwd 510A needs to be turned off when the NCR-MT 520A transitions to the RRC idle state. When the NCR apparatus 500A is not considered as a network-controlled repeater (for example, when the NCR-MT 520A is in the RRC idle state), the NCR apparatus 500A may be allowed to operate as a conventional RF repeater. Therefore, as in the case of the RLF, the NCR-Fwd 510A may be turned off when the NCR-MT 520A is released to the RRC idle state by the gNB 200.

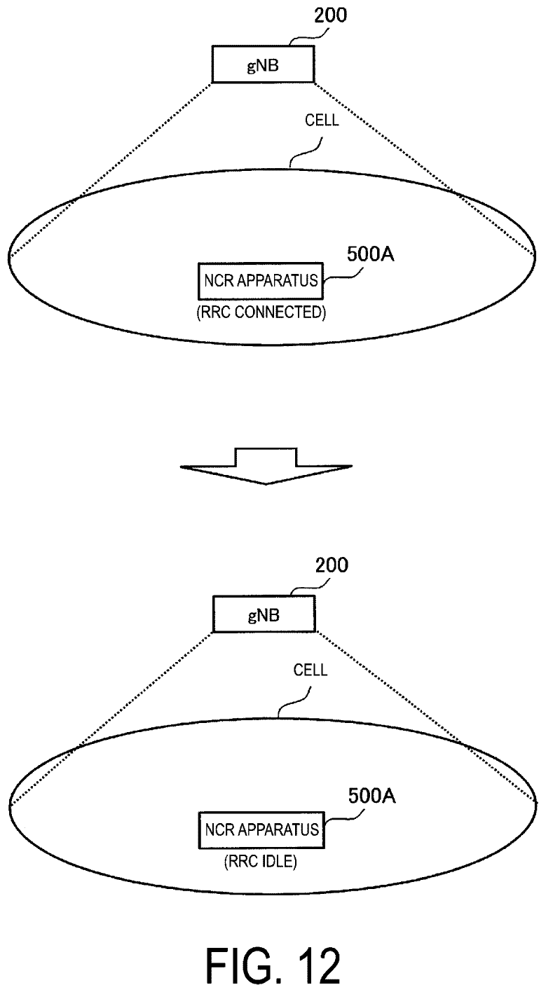

FIG. 12 is a diagram for explaining the operation according to the first embodiment. The NCR apparatus 500A includes the NCR-Fwd 510A that performs a relay operation of relaying a radio signal transmitted between the network 5 and the UE 100, and the NCR-MT 520A that receives a control signal (NCR control signal) used to control the NCR-Fwd 510A from the network 5.

In the first embodiment, the NCR-MT 520A determines that there is no control from the network 5 in response to transitioning from the RRC connected state to the RRC idle state. The NCR apparatus 500A may perform a predetermined implementation-dependent operation in response to determining that there is no control from the network 5. The implementation-dependent operation may be a relay operation independent of the control from the network 5 (that is, an operation of a conventional RF repeater). In this way, autonomously operating as a conventional RF repeater allows the operation of extending the coverage of the gNB 200 to be continued. As described above, in the first embodiment, the NCR apparatus 500A, when transitioning to the RRC idle state, determines that there is no control from the network 5, and can operate as a conventional RF repeater.

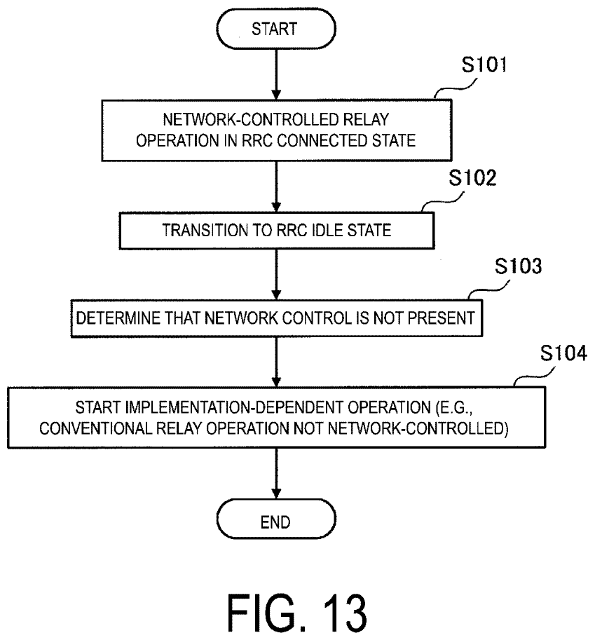

FIG. 13 is a flowchart illustrating an operation example of the NCR apparatus 500A according to the first embodiment.

In step S101, the NCR-MT 520A is in the RRC connected state in a cell of the gNB 200. The NCR-MT 520A in the RRC connected state receives an NCR control signal such as the side control information from the gNB 200, and controls the NCR-Fwd 510A in response to the NCR control signal.

In step S102, the NCR-MT 520A transitions to the RRC idle state. For example, the NCR-MT 520A transitions to the RRC idle state in response to receiving an RRC Release message from the gNB 200. Alternatively, the NCR-MT 520A may transition to the RRC idle state in response to detecting the RLF and failing in the RRC connection re-establishment (i.e. failing to find a suitable cell). Alternatively, the NCR-MT 520A may transition to the RRC idle state in response to an initial access (power-on).

In step S103, the NCR-MT 520A determines (detects) that there is no network control. The NCR-MT 520A may notify the upper layers that there is no network control. The NCR apparatus 500A (NCR-MT 520A) may determine whether to behave as the NCR apparatus 500A or perform an implementation-dependent operation (for example, an operation of a conventional RF repeater) as described in a variation of the first embodiment. When the NCR apparatus 500A (NCR-MT 520A) holds the configuration information for performing the operation of the conventional RF repeater in advance, the NCR apparatus 500A (NCR-MT 520A) may read the configuration information.

In step S104, the NCR apparatus 500A may start the implementation-dependent operation. For example, the NCR apparatus 500A operates as a conventional RF repeater.

Note that the operation of step S104 may be changed depending on the cause of the transition to the RRC idle state. For example, the NCR apparatus 500A, at the time of the initial access, may not operate as a conventional RF repeater and may not perform a relay operation (that is, may turn off the NCR-Fwd 510A).

The NCR apparatus 500A may not perform the relay operation when the NCR-MT 520A transitions to the RRC idle state due to the RLF. This is because when an RLF occurs due to a poor reception level (for example, reference signal received power (RSRP)) from the cell, the relay operation is wasted. However, the NCR apparatus 500A may perform a relay operation (for example, an operation of a conventional RF repeater) when, for example, a reception level from the cell is higher than a threshold. The threshold may be configured for the NCR-MT 520A from the gNB 200. For example, the gNB 200 configures the threshold by the NCR control signal. The threshold may be compared with not only the reception level (RSRP) but also another radio quality index such as RSRQ and/or SINR. Note that the NCR apparatus 500A may stop the relay operation when the reception level (and/or other radio quality indexes) from the cell is lower than the threshold. The RLF described above may be regarded as a kind of the threshold.

Furthermore, the NCR apparatus 500A, when transitioning to the RRC idle state in response to receiving the RRC Release message from the gNB 200, may perform a relay operation (for example, an operation of a conventional RF repeater). In this case, the NCR apparatus 500A may perform the relay operation by forming a beam by independent control instead of a beam (that is, an antenna weight) designated by the network 5 (gNB 200). For example, the NCR apparatus 500A calculates the antenna weight using UE 100/gNB 200 position estimation by a sensor and/or an arrival direction of a radio signal.

### (1.5) Variation of First Embodiment

In the first embodiment described above, an example is described in which the NCR apparatus 500A performs a predetermined operation when the NCR-MT 520A transitions to the RRC idle state. In contrast, in the variation, the network 5 (gNB 200) can designate the operation of the NCR apparatus 500A when the NCR-MT 520A transitions to the RRC idle state.

In the variation, the NCR-MT 520A receives, from the network 5 (gNB 200), the configuration information indicating whether the NCR apparatus 500A performs a relay operation independent of the control from the network 5 (i.e., an operation of a conventional RF repeater) after the transition to the RRC idle state. The NCR apparatus 500A performs the operation based on the configuration information in response to determining that there is no control from the network 5. As described above, in the variation, the gNB 200 configures for the NCR-MT 520A with whether the NCR apparatus 500A may operate as a conventional RF repeater when the NCR-MT 520A transitions to the RRC idle state. This allows the gNB 200 to designate the operation of the NCR-MT 520A when the NCR-MT 520A transitions to the RRC idle state.

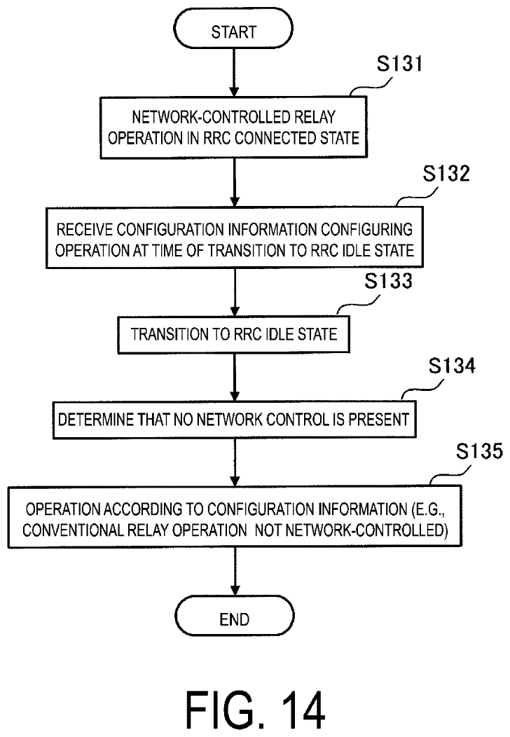

FIG. 14 is a flowchart illustrating an operation example of the NCR apparatus 500A according to the variation of the first embodiment. Here, differences from the operation of FIG. 13 are mainly described, and overlapping description is omitted.

In step S131, the NCR-MT 520A is connected to the gNB 200, and the NCR-Fwd 510A is controlled according to the side control information or the like.

In step S132, the NCR-MT 520A receives from the gNB 200 the configuration information for configuring the operation at the time of the transition to the RRC idle state. The configuration information indicates whether to operate as a conventional RF repeater. For example, the gNB 200 transmits the configuration information in an RRC Reconfiguration message to the NCR-MT 520A. The gNB 200 may transmit the configuration information in the RRC message to the NCR-MT 520A.

Here, the gNB 200 may configure for the NCR-MT 520A in association therewith information related to the cause of the RRC idle state transition. That is, the gNB 200 configures the NCR-MT 520A with the operation at the time of the RRC idle state transition for each cause of the RRC idle state transition. Here, the “cause” may be, for example, any one of 1) an RRC Release occurring (that is, when the gNB 200 intentionally makes a transition to the RRC idle state), 2) an RLF occurring (to be specific, when the gNB 200 unintentionally transitions to the RRC idle state, such as when cell selection or RRC connection reestablishment is failed), and 3) an initial access occurring. For example, when the gNB 200 causes the NCR-MT 520A to transition to the RRC idle state in the RRC Release, the gNB 200 may permit it to operate as a conventional RF repeater. The gNB 200 may configure the NCR-Fwd 510A to be turned off (an implementation-dependent relay operation to be not permitted) when NCR-MT 520A transitions to the RRC idle state due to the RLF.

Note that the order of step S131 and step S132 may be inverted.

In step S133, the NCR-MT 520A transitions to the RRC idle state.

In step S134, the NCR-MT 520A determines (detects) that there is no network control.

In step S135, the NCR apparatus 500A performs an operation in accordance with the configuration information in step S132 and controls the relay operation (NCR-Fwd 510A).

In the variation, an example is in which the gNB 200 transmits the configuration information for configuring the operation at the time of the RRC idle state transition to the NCR-MT 520A by dedicated signaling. For example, the gNB 200 may transmit the configuration information by broadcast signaling (for example, system information block (SIB)). For example, the gNB 200 broadcasts in the SIB the configuration information indicating whether the NCR apparatus 500A may operate as a conventional RF repeater. The NCR apparatus 500A, when permitted to operate as a conventional RF repeater, may behave as a conventional RF repeater. On the other hand, when not permitted, the NCR apparatus 500A may behave as the NCR apparatus 500A and operate according to technical specifications for the NCR apparatus 500A (for example, turning off the NCR-Fwd 510A in the RRC idle state).

### (2) Second Embodiment

A second embodiment is described focusing on differences from the first embodiment. The second embodiment may be performed in combination with the first embodiment.

As described above, after the NCR-MT 520A transitions to the RRC inactive state, the NCR apparatus 500A can turn on or off the NCR-Fwd 510A in accordance with the latest configuration information received from the gNB 200. Similarly, after the NCR-MT 520A transitions to the RRC inactive state, the NCR apparatus 500A may also turn on or off the NCR-Fwd 510A in accordance with the latest (last) configuration information received from the gNB 200.

However, on the assumption that the NCR-Fwd 510A permanently maintains the RRC idle state or the RRC inactive state after the NCR-MT 520A transitions to the RRC idle state or the RRC inactive state, the NCR-Fwd 510A may disadvantageously continue the operation in accordance with the current configuration information (that is, the latest configuration information) permanently. For example, when the NCR apparatus 500A in the RRC idle state or the RRC inactive state permanently turns on the NCR-MT 520A, interference or the like may occur that is unexpected by the network 5.

Therefore, in the second embodiment, the NCR apparatus 500A controls NCR-Fwd 510A with the current configuration only during a certain period of time after the transition to the RRC idle state or the RRC inactive state. In other words, there is provided a time limit during which the NCR apparatus 500A in the RRC idle state or the RRC inactive state continues the operation in accordance with the current configuration information (for example, turning the NCR-Fwd 510A to the ON state).

To be more specific, in the second embodiment, first, the NCR-MT 520A in the RRC connected state receives the configuration information (NCR control signal) for configuring the relay operation from the gNB 200. Second, the NCR-MT 520A transitions from the RRC connected state to the RRC idle state or the RRC inactive state. Third, the NCR apparatus 500A holds the configuration information (NCR control signal) only during a period until a certain amount of time elapses after the transitioning to the RRC idle state or the RRC inactive state, and performs the operation in accordance with the configuration information (NCR control signal).

The NCR apparatus 500A may discard the configuration information (NCR control signal) when the certain amount of time elapses after the transitioning to the RRC idle state or the RRC inactive state. This allows a memory capacity of the NCR apparatus 500A to be saved.

The NCR apparatus 500A may initiate a procedure of transitioning to the RRC connected state when the certain amount of time elapses after the transitioning to the RRC idle state or the RRC inactive state. The procedure is an RRC connection establishment procedure when the NCR-MT 520A is in the RRC idle state or an RRC connection recovery procedure when the NCR-MT 520A is in the RRC inactive state. When the NCR-MT 520A transitions to the RRC connected state, the NCR-MT 520A can acquire a new NCR control signal (for example, NCR configuration information) from the gNB 200.

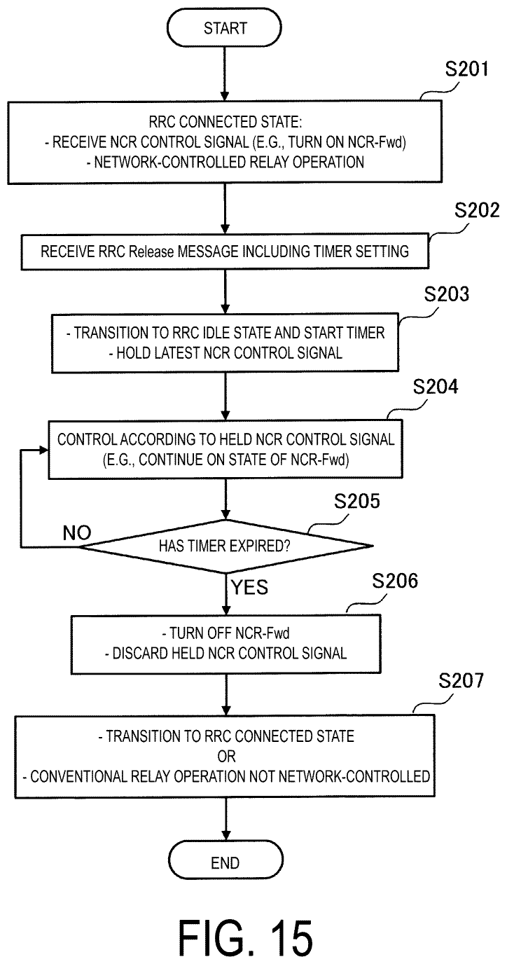

FIG. 15 is a flowchart illustrating an operation example of the NCR apparatus 500A according to the second embodiment.

In step S201, the NCR-MT 520A in the RRC connected state controls the NCR-Fwd 510A to operate in accordance with the NCR control signal (NCR configuration information and/or NCR control information) received from the gNB 200. Assume that the NCR-MT 520A receives the NCR control signal for turning on the NCR-Fwd 510A from the gNB 200.

In step S202, the NCR-MT 520A in the RRC connected state receives the RRC Release message including a timer setting from the gNB 200. The timer setting includes a timer value indicating a time to be set in a timer for measuring a certain period of time during which the NCR control signal is continued to be applied. When the NCR apparatus 500A includes a plurality of NCR-Fwds 510A, the timer value may be set for each NCR-Fwd 510A. For example, the timer value may be set in association with an NCR-Fwd ID (index).

Although the gNB 200 transmits the timer setting in the RRC Release message to the NCR-MT 520A in this operation example, the gNB 200 may transmit the timer setting in the RRC Reconfiguration message to the NCR-MT 520A.

In step S203, the NCR-MT 520A transitions to the RRC idle state or the RRC inactive state and starts the timer based on the timer setting. The NCR-MT 520A holds the current NCR control signal while the timer is running.

In step S204, the NCR-MT 520A controls the NCR-Fwd 510A in accordance with the NCR control signal while the timer is running. The NCR-MT 520A may notify the upper layer that the timer has started or is running, and the upper layer may control the NCR-Fwd 510A based on the notification.

In step S205, the NCR-MT 520A determines whether the timer expires. When the timer does not expire (step S205: NO), in step S204, the NCR-MT 520A continues to control the NCR-Fwd 510A in accordance with the held NCR control signal.

On the other hand, when the timer expires (step S205: YES), in step S206, the NCR-MT 520A turns off the NCR-Fwd 510A in response to the expiration of the timer. The NCR-MT 520A may notify the upper layer that the timer expires, and the upper layer may control the NCR-Fwd 510A based on the notification.

In step S206, the NCR-MT 520A may discard the held NCR control signal in response to the expiration of the timer.

In step S207, the NCR-MT 520A may initiate the RRC connection establishment procedure or the RRC connection recovery procedure in response to the expiration of the timer and transition to the RRC connected state. In this procedure, the NCR-MT 520A transmits, as a Msg3, an RRC Setup Request message or an RRC Resume Request message to the gNB 200. The NCR-MT 520A may include information, as Cause IE, for example, indicating a connection request for updating the NCR control signal (for example, NCR configuration information) in the Msg3. Alternatively, the NCR-MT 520A may notify the information in a Msg5. The NCR-MT 520A may notify the information in Physical Random Access Channel (PRACH) partitioning of a Msg1. The NCR-MT 520A after transitioning to the RRC connected state receives a new NCR control signal (for example, new NCR configuration information) from the gNB 200.

Alternatively, in step S207, the NCR-MT 520A may start a relay operation as a conventional RF repeater not network-controlled in response to the expiration of the timer.

### (3) Third Embodiment

A third embodiment is described focusing on differences from the first and second embodiments. The third embodiment may be performed in combination with the first and/or second embodiments.

As described above, the gNB 200 can call the NCR-MT 520A in the RRC inactive state by gNB 200 initiated paging (so-called RAN paging) to cause the NCR-MT 520A to transition to the RRC connected state. Therefore, it is easy for the gNB 200 to control the NCR-MT 520A (NCR apparatus 500A).

On the other hand, the gNB 200 cannot call the NCR-MT 520A in the RRC idle state by RAN paging. To be more specific, in order to call the NCR-MT 520A in the RRC idle state, CN 20 (to be more specific, AMF 300A) initiated paging (so-called CN paging) needs to be used. Therefore, it is difficult for the gNB 200 to control the NCR-MT 520A in the RRC idle state.

Therefore, in the third embodiment, the gNB 200 requests CN paging from the AMF 300A in order to call the NCR-MT 520A in the RRC idle state. This enables to call and cause the NCR-MT 520A in the RRC idle state to transition to the RRC connected state, and makes it easy for the gNB 200 to control the NCR-MT 520A (NCR apparatus 500A).

To be more specific, in the third embodiment, the gNB 200 having caused the NCR-MT 520A to transition from the RRC connected state to the RRC idle state transmits, to the AMF 300A (core network apparatus), a paging request for requesting paging from the AMF 300A to the NCR apparatus 500A (i.e., CN paging).

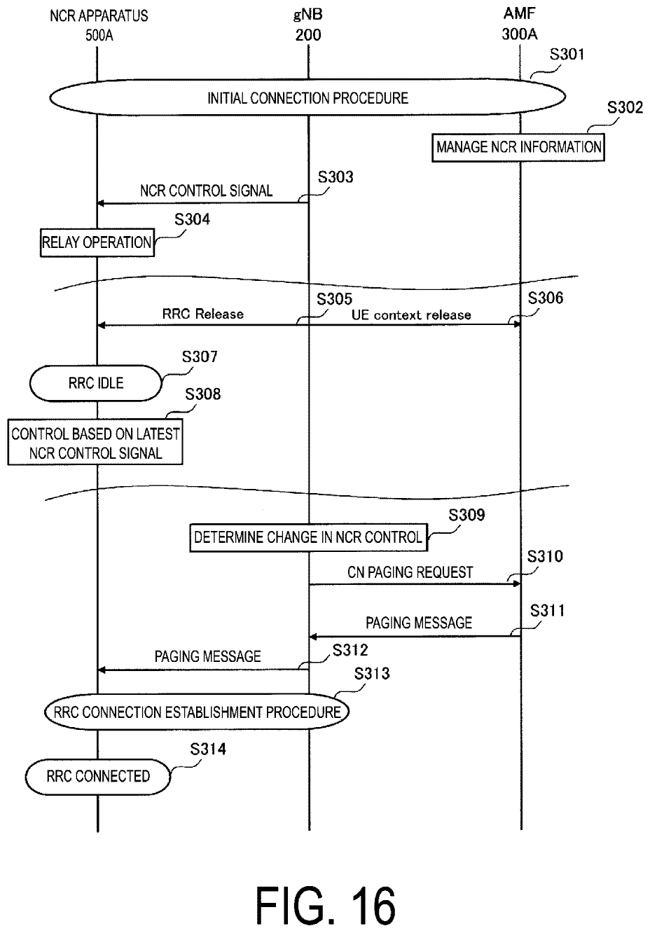

FIG. 16 is a diagram illustrating an operation example of the mobile communication system 1 according to the third embodiment. Assumed that communication between the gNB 200 and the AMF 300A is performed over the NG interface.

In step S301, the NCR apparatus 500A (NCR-MT 520A) performs an initial connection procedure to the network 5. The initial connection procedure includes an RRC connection establishment procedure between the NCR-MT 520A and the gNB 200 and an authentication and registration procedure between the NCR-MT 520A and the AMF 300A.

In step S302, the AMF 300A may perform authentication of NCR-MT 520A at the time of the initial connection to the NCR-MT 520A. The AMF 300A may manage (hold) a UE ID of the NCR-MT 520A in association with an identification ID. Here, the UE ID may be International Mobile Subscriber Identity (IMSI) or 5G-S-Temporary Mobile Subscriber Identity (TMSI). The AMF 300A may notify the gNB 200 of the identification ID, for example, in a UE context setup message.

Alternatively, in step S302, the AMF 300A may manage (hold) the UE ID of the NCR-MT 520A as the UE ID of the NCR apparatus 500A. The AMF 300A may manage (hold) the UE ID in association with the gNB 200 to which the NCR-MT 520A belongs (the gNB 200 communicating with the AMF 300A). The gNB 200 may inform the AMF 300A of a cell ID of the cell to which the NCR-MT 520A belongs, e.g. in a UE context modification message. The AMF 300A may manage (hold) the UE ID in association with the cell ID.

In step S303, the gNB 200 may transmit an NCR control signal such as side control information to the NCR-MT 520A in the RRC connected state.

In step S304, the NCR-MT 520A may control the NCR-Fwd 510A in accordance with the NCR control signal received from the gNB 200.

In step S305, the gNB 200 transmits an RRC Release message to the NCR-MT 520A to cause the NCR-MT 520A to transition to the RRC idle state (step S307). In step S306, the gNB 200 transmits a UE Context release message to the AMF 300A. The gNB 200 and the AMF 300A may hold the identification ID even after the UE context is deleted. The AMF 300A may hold the UE ID of the NCR-MT 520A even after the UE context is deleted. The gNB 200 and the AMF 300A may hold the cell ID even after the UE context is deleted.

In step S308, the NCR-MT 520A may control the NCR-Fwd 510A in accordance with the NCR control signal last received from the gNB 200. The NCR-Fwd 510A may be ON or OFF.

In step S309, the gNB 200 determines change in the control (configuration/operation) of the NCR apparatus 500A in the RRC idle state. For example, the gNB 200 determines to change the NCR configuration information in order to change the scheduling of radio resources.

In step S310, the gNB 200 transmits a CN paging request to the AMF 300A. The CN paging request includes at least one selected from the group consisting of information indicating a request for calling the NCR apparatus 500A, the identification ID described above, and the cell ID described above (to be specific, the cell ID of the cell in which the NCR apparatus 500A in the RRC idle state is located, or the cell ID of the cell whose configuration needs to be changed).

The AMF 300A, upon receiving the CN paging request from the gNB 200, specifies which NCR apparatus 500A is to call based on the information included in the CN paging request. For example, when the identification ID is included in the CN paging request, the AMF 300A specifies the UE ID of the NCR apparatus 500A associated with the identification ID. When the cell ID is included in the CN paging request, the AMF 300A specifies the UE ID of the NCR apparatus 500A associated with the cell ID. Note that when no cell ID is included in the CN paging request, the AMF 300A may call all the NCR apparatuses 500A associated with the gNB 200 that has transmitted the request.

In step S311, the AMF 300A transmits a paging message including the UE ID of the specified NCR apparatus 500A to the gNB 200.

In step S312, the gNB 200 transmits the paging message from the AMF 300A on a paging control channel (PCCH). When the NCR apparatus 500A (NCR-MT 520A) receives a paging message including the UE ID of the NCR apparatus 500A itself, the NCR apparatus 500A determines that the NCR apparatus 500A is being called.

In step S313, the NCR-MT 520A performs the RRC connection establishment procedure with the gNB 200 in response to receiving the paging message.

In step S314, the NCR-MT 520A transitions from the RRC idle state to the RRC connected state.

### (4) Fourth Embodiment

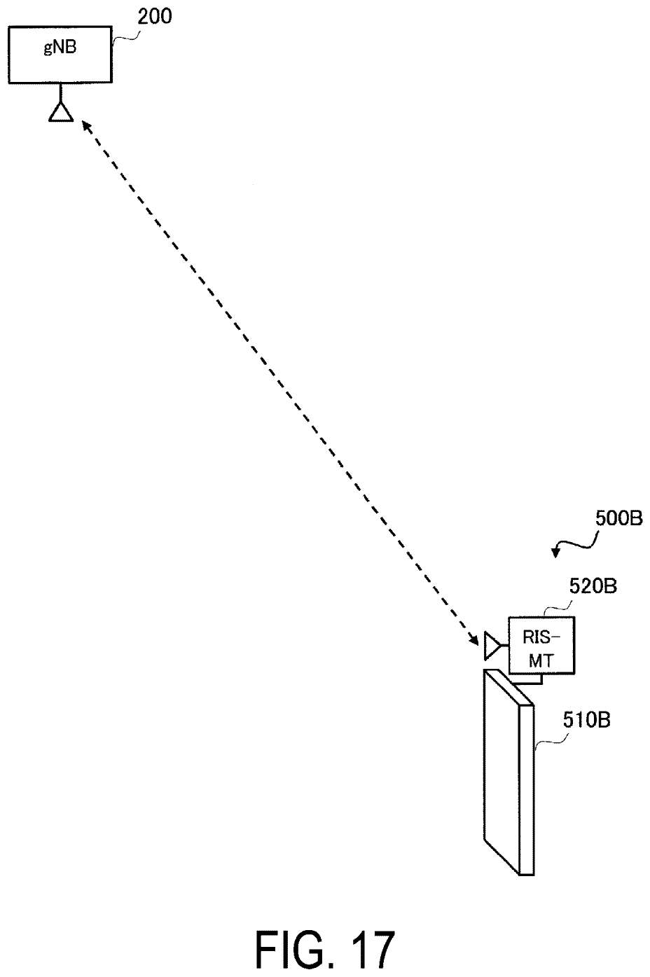

A fourth embodiment is described focusing on differences from the above-described embodiments. As illustrated in FIG. 17, a relay apparatus according to the fourth embodiment is a Reconfigurable Intelligent Surface (RIS) apparatus 500B that changes a propagation direction of an incident radio wave (radio signal) by reflection or refraction. The “NCR” in the above-described embodiments may be read as the “RIS”.

The RIS is a type of a relay device (hereinafter, also referred to as a “RIS-Fwd”) capable of performing beamforming (directivity control) in the same and/or similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B which is a control terminal for controlling the RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably configured. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably configured.

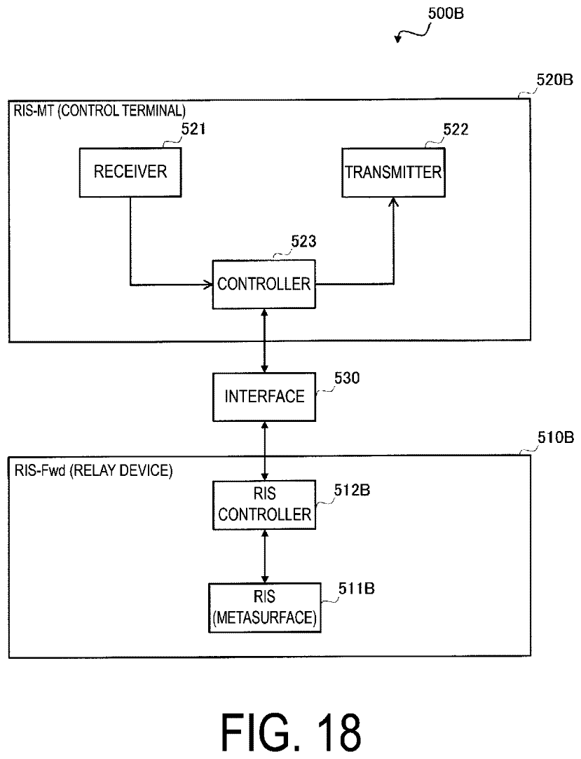

FIG. 18 is a diagram illustrating a configuration example of the RIS-Fwd (relay device) 510B and the RIS-MT (control terminal) 520B according to the embodiment. The RIS-MT 520B includes a receiver 521, a transmitter 522, and a controller 523. The configuration like this is the same as, and/or similar to, that in the embodiment described above. The RIS-Fwd 510B includes a RIS 511B and a RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (5) Other Embodiments

In the above-described embodiment, an example in which the relay apparatus that performs relay transmission is the NCR apparatus 500A or the RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

In the embodiment described above, an example in which the base station is an NR base station (gNB) has been described. However, the base station may be an LTE base station (an eNB). The base station may be a relay node such as the IAB node. The base station may be a distributed unit (DU) of the IAB node.

A program causing a computer to execute each of the processes performed by the communication apparatus according to the embodiment described above, for example, the UE 100 (NCR-MT 520A and RIS-MT 520B), the gNB 200, or the relay apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processes performed by the UE 100, the gNB 200, or the relay apparatus may be integrated, and at least a part of the UE 100, the gNB 200, or the relay apparatus may be implemented as a semiconductor integrated circuit (chipset, System on a chip (SoC)).

The functions realized by the UE 100, the gNB 200 (network node), or the relay apparatus may be implemented in a circuitry or a processing circuitry including general-purpose processors, special-purpose processors, integrated circuits, application specific integrated circuits (ASICs), a central processing unit (CPU), conventional circuitry, and/or combinations thereof programmed to realize the described functions. The processors may include transistors and other circuits, and may be considered as a circuitry or a processing circuitry. The processors may be programmed processors that execute programs stored in the memory. As used herein, a circuitry, a unit, and means are hardware programmed to achieve, or hardware performing, the recited functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design modifications can be made without departing from the gist of the present disclosure.

### (6) Supplementary Notes

Features relating to the embodiments described above are described below as supplements.

### Supplementary Note 1

A communication method using a relay apparatus including a relay device configured to perform a relay operation of relaying a radio signal transmitted between a network and a user equipment, and a control terminal configured to receive a control signal used for control of the relay device from the network, the communication method including the steps of: transitioning, by the control terminal, to a radio resource control (RRC) idle state; and determining, by the relay apparatus, that the control from the network is not present, in response to the transitioning to the RRC idle state.

### Supplementary Note 2

The communication method according to supplementary note 1, further including: performing, by the relay apparatus, a predefined implementation-dependent operation, in response to the determining that the control from the network is not present.

### Supplementary Note 3

The communication method according to supplementary note 2, wherein the implementation-dependent operation is a relay operation independent of the control from the network.

### Supplementary Note 4

The communication method according to any one of supplementary notes 1 to 3, further including:
receiving, by the control terminal, configuration information from the network, the configuration information indicating whether the relay apparatus performs the relay operation independent of the control from the network after the transitioning to the RRC idle state; and performing, by the relay apparatus, an operation based on the configuration information, in response to the determining that the control from the network is not present.

### Supplementary Note 5

A communication method using a relay apparatus including a relay device configured to perform a relay operation of relaying a radio signal transmitted between a network and a user equipment, and a control terminal configured to receive a control signal used for control of the relay device from the network, the communication method including the steps of:
receiving, by the control terminal, in a radio resource control (RRC) connected state, configuration information used to configure the relay operation from the network;
transitioning, by the control terminal, to an RRC idle state or an RRC inactive state; and
performing, by the relay apparatus, in the RRC idle state or the RRC inactive state, an operation in accordance with the configuration information only during a period until a certain amount of time elapses after the transitioning.

### Supplementary Note 6

The communication method according to supplementary note 5, further including: a step of discarding, by the relay apparatus, the configuration information when the certain amount of time elapses after the transitioning.

### Supplementary Note 7

The communication method according to supplementary note 5 or 6, further including: a step of initiating, by the relay apparatus, a procedure of transitioning from the RRC idle state or the RRC inactive state to the RRC connected state when the certain amount of time elapses after the transitioning.

### Supplementary Note 8

A communication method using a relay apparatus including a relay device configured to perform a relay operation of relaying a radio signal transmitted between a network and a user equipment, and a control terminal configured to receive a control signal used for control of the relay device from the network, the communication method including the steps of:
causing, by a network node included in the network, the control terminal to transition from a radio resource control (RRC) connected state to an RRC idle state; and
transmitting, by the network node, a paging request to a core network apparatus included in the network, the paging request requesting paging from the core network apparatus to the relay apparatus.

### REFERENCE SIGNS

1: Mobile communication system
100: UE
200: gNB
210: Transmitter
220: Receiver
230: Controller
240: Backhaul communicator
500A: NCR apparatus
510A: NCR-Fwd
520A: NCR-MT
500B: RIS apparatus
511A: Wireless unit
511a: Antenna
511b: RF circuit
511c: Directivity controller
512A: NCR controller
512B: RIS controller
521: Receiver
522: Transmitter
523: Controller
530: Interface

1. A communication method using a repeater node comprising a repeater function configured to perform a forward operation of forwarding of a radio signal transmitted between a network and a user equipment, and a control termination, the communication method comprising the steps of:
receiving from the network, by the control termination in a radio resource control (RRC) connected state, configuration information configuring the forward operation;
transitioning, by the control terminal, from the RRC connected state to an RRC inactive state; and
continuing to perform the forward operation in accordance with the configuration information, by the repeater function in the RRC inactive state.

2. The communication method according to claim 1, further comprising:
discarding, by the repeater node, the configuration information when the certain amount of time elapses after the transitioning.

3. The communication method according to claim 1, further comprising:
initiating, by the repeater node, a procedure of transitioning from an RRC idle state or the RRC inactive state to the RRC connected state when the certain amount of time elapses after the transitioning.

4. A repeater node comprising a repeater function configured to perform a forward operation of a radio signal transmitted between a network and a user equipment, and a control terminal, wherein:
the control terminal is configured to:
receive, in a radio resource control (RRC) connected state, configuration information for configuring the forward operation from the network; and
transition from the RRC connected state to an RRC inactive state; and
the repeater function is configured to:
continue to perform the forward operation in accordance with the configuration information in the RRC inactive state.

5. A non-transitory computer-readable medium storing instructions which, when executed by a processor of a repeater node, cause the repeater node to perform a process, the repeater node comprising a repeater function configured to perform a forward operation of a radio signal transmitted between a network and a user equipment, and a control terminal, the process comprising:
receiving, in a radio resource control (RRC) connected state, configuration information for configuring the forward operation from the network;
transitioning from the RRC connected state to an RRC inactive state; and
continuing the forward operation in accordance with the configuration information in the RRC inactive state.

6. A chipset configured to execute the process stored on the non-transitory computer-readable medium of claim 5.

7. A system comprising a network, a user equipment, and the repeater node of claim 4.
